(19) United States
(12) Patent Application Publication
(10) Pub. No.: US 2006/0230056 A1
(43) Pub. Date: Oct. 12, 2006

(54) Method and a device for visual management of metadata

(75) Inventor: Antti Aaltonen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/101,180

(22) Filed: Apr. 6, 2005

(51) Int. Cl. G06F 7/00

(52) U.S. Cl. 707/102

(57) ABSTRACT

A method and a device for visual management of metadata. An area with a plurality of data elements is visualized (504) to the user who determines (508) a route on the area, said route including a number of preferred elements belonging to the plurality of elements, which is detected (512). The preferred elements shall act as targets for a predefined metadata operation (514), e.g. change of a metadata attribute value.

### BACKGROUND OF THE INVENTION

The present invention relates to a method and a device for managing metadata in electronic appliances. Especially the provided solution pertains to visual metadata management of media elements arranged into groups.

Due to the exponentially growing amount of electronically stored data in various electronic appliances such as computers, mobile phones, digital cameras, media recorders/playback devices, and shared (network) media directories, also requirements set for different media editing and managing tools have risen considerably during the last two decades. The traditional way of handling electronically stored data, e.g. in binary form, is to represent separate data elements textually by visualizing identifiers thereof on a computer display and respectively, to receive editing etc commands targeted to a number of data elements via a computer keyboard on a command word basis.

Metadata is data about data. It may, for example, describe when and where a certain data element was created, what it is about, who created it, and what's the used data format. In other words, metadata gives supplementary means for a data element's further exploitation, being often optional but still very useful as will become apparent. To give a more specific example, an image file (˜image element) may contain metadata attributes about aperture value, shutter speed, flash type, location, event, people being photographed etc to properly insert the image into a suitable context. Some of these attributes could and should be defined automatically, since it is not realistic to assume that users would have the time and energy to manually annotate their content to a large extent.

Single data elements can often be painlessly edited and provided with metadata even by utilizing traditional textual input means but the situation changes radically in case of collections comprising a plurality of elements.

One could consider an example from the field of image collection(s) management as it certainly is one of the many applications in which the total number of elements (e.g. holiday photos) easily exceeds the limit considered as bearable for old-fashioned one-by-one editing other than sporadically, especially what comes to adding/modifying metadata attributes that often are numerous and somewhat detailed if meant to be of any good. Adobe Photoshop Album is one of the products that reflect the current state of the art in image collections management, see FIG. 1 for illustration. A user interface (henceforth UI) 102 consists of a grid providing a content view to a resource 104 (e.g. a file folder or specific image collection) with a plurality of images and a tree showing tag (keyword) hierarchy with tag categories (metadata attributes) 108 and tags (attribute values) 110. The user can select 112 certain tags 114 for sorting/filtering the image view. Tags associated with each image are displayed 106 under the corresponding image. Tags representing different metadata attribute values may be drag-and-dropped onto the images to create the associations.

Although the prior art solution described above certainly is applicable in a number of cases and typically prevails over mere textual editing-based methods, it is not an all-purpose ultimate solution. Performing drag-and-drop operations with hand-held device may be tedious, since performing this operation requires very controlled movement of the hand. E.g. the user is sitting in a bus and while s/he is performing the operation, the bus rides over a bump, and due to this, the operation is disturbed, it may cause unexpected effects. Yet another point is that when an extensive image collection should be annotated with metadata from scratch, even drag-and-drop or other classic multiple selection methods that work on visualized elements, e.g. modifier keys SHIFT or CONTROL pressed on a keyboard while selecting items in Microsoft Windows, may appear nothing but tedious. Using extra hardware modifier keys for performing multiple selections with hand-held devices may be challenging due to the small physical size of the device; the device may not have room for extra keys of this kind. Humans also have some natural ability to perceive (e.g. visually) complex compositions' essential, distinctive features directly without slavishly chopping them first into basic building blocks for performing perfectly exact machine-like classification, which is the approach computers usually have been programmed to follow, though it omits some human strengths.

### BRIEF SUMMARY OF THE INVENTION

The object of the present invention is to overcome the aforesaid problem of awkward manual editing/managing of visualized objects and related metadata in electronic appliances. The object is reached by applying metadata attributes with preferred values to data elements that are selected through e.g. painting-like, interconnecting gestures via the device UI such as a control pen, a joystick, a mouse, a touch pad/screen or another appropriate control accessory.

The utility of the invention arises from its inherent ability to provide intuitive and fast means for copying several metadata attribute values to a plurality of items. Compared to the methods provided by the prior art where the multiple item selection had to be done with e.g. modifier keys, the invention provides three major benefits: 1) less input required, 2) less hardware keys required, and 3) reduced risk of selecting/deselecting items accidentally e.g. due to a failure in pressing a multiple selection button upon (de)selecting a new element to the element set while navigating in content grid, which could empty all other elements from the set. In case of accidental (de)selection, also error recovery can be accomplished fluently.

According to the invention, a method for directing a metadata operation at a number of electronically stored data elements in an electronic device has the steps of
visualizing an area with a number of data elements on a display device to a user,
obtaining control information about a user-defined route between user-defined start and end points on the visualized area comprising said number of data elements,
specifying on the basis of the route such data elements belonging to said number of data elements over which the route passed, and
performing the metadata operation on the specified data elements.

In another aspect of the invention, an electronic device comprises
data output means for visualizing an area with a number of data elements,
data input means for receiving control information from a user, and
processing means configured to determine on the basis of the control information a user-defined route between user-defined start and end points on the visualized area comprising said number of data elements and to specify on the basis of the route such data elements belonging to said number of data elements over which the determined route passed, whereupon further configured to perform a metadata operation on the specified data elements.

The overall user-defined route may, in addition to one start and end point with a continuous portion between them, be considered to consist of several sub-routes between a plurality of start and end points, i.e. it is a multi-selection route.

The term “metadata operation” may incorporate, for example, setting one or multiple predefined metadata attributes and/or associated values for the specified elements, i.e. elements which were located within the route are associated with the metadata attribute or/and the attribute value; in computing systems the attributes normally carry at least initial or “no-specific-value-set” type preset values if no specific values have been allocated yet. However, other metadata related actions might also be directed based on the method as being evident from the teachings thereof.

In an embodiment of the invention a user equipped with the device of the invention is willing to annotate his electronic holiday photo album with various metadata attributes for easier utilization in the future. The user first selects one source image with preferred metadata attributes he would like to apply to other images respectively. Then he paints a route over some selected images that, thanks to the inventive method, also receive, i.e. they are copied, the metadata attributes and/or metadata attribute values of the source image. Different variations of this scheme are also presented hereinafter.

### BRIEF DESCRIPTION OF THE DRAWING

In the following, the invention is described in more detail by reference to the attached drawings, wherein

FIG. 1 illustrates a partial screen shot of a prior art image managing application.

FIG. 2 depicts a series of screen shots of a selection of a source image in an image browser application capable of executing the method of the invention.

FIG. 3A illustrates the provision of metadata into a plurality of images that reside on the route determined by the user.

FIG. 3B illustrates the route definition in parts.

FIG. 4 illustrates how image selections can be reversed (˜redefinition of the route) in the method of the invention.

FIG. 5A is a flow diagram of one realization of the method of the invention.

FIG. 5B is a supplementary flow diagram determining additional steps of the method presented by FIG. 5A.

FIG. 6 is a high-level block diagram of an electronic device adapted to carry out the proposed method.

### DETAILED DESCRIPTION OF THE INVENTION

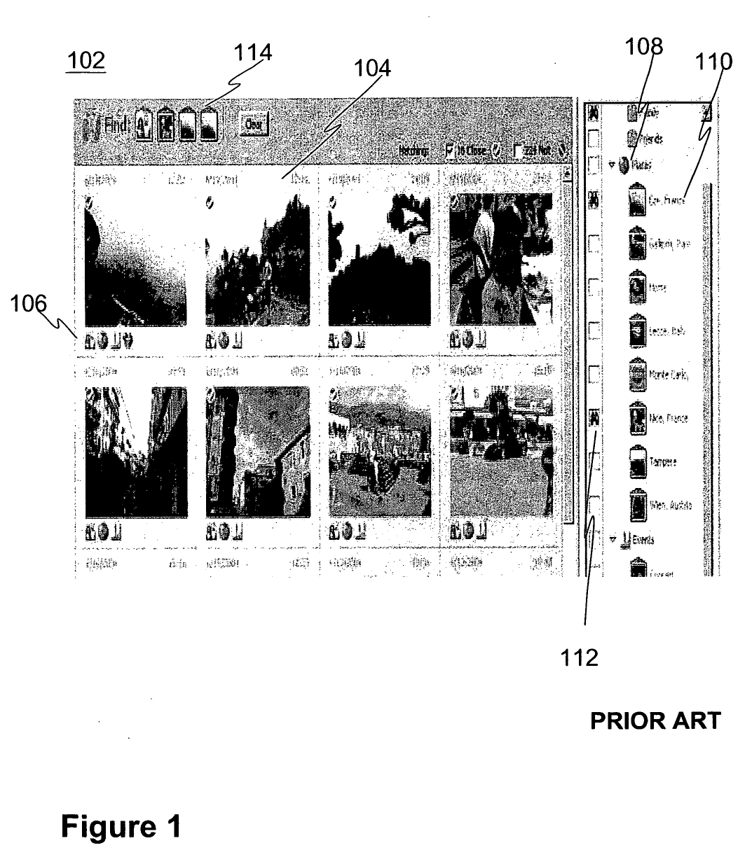

FIG. 1 was already reviewed in conjunction with the description of related prior art.

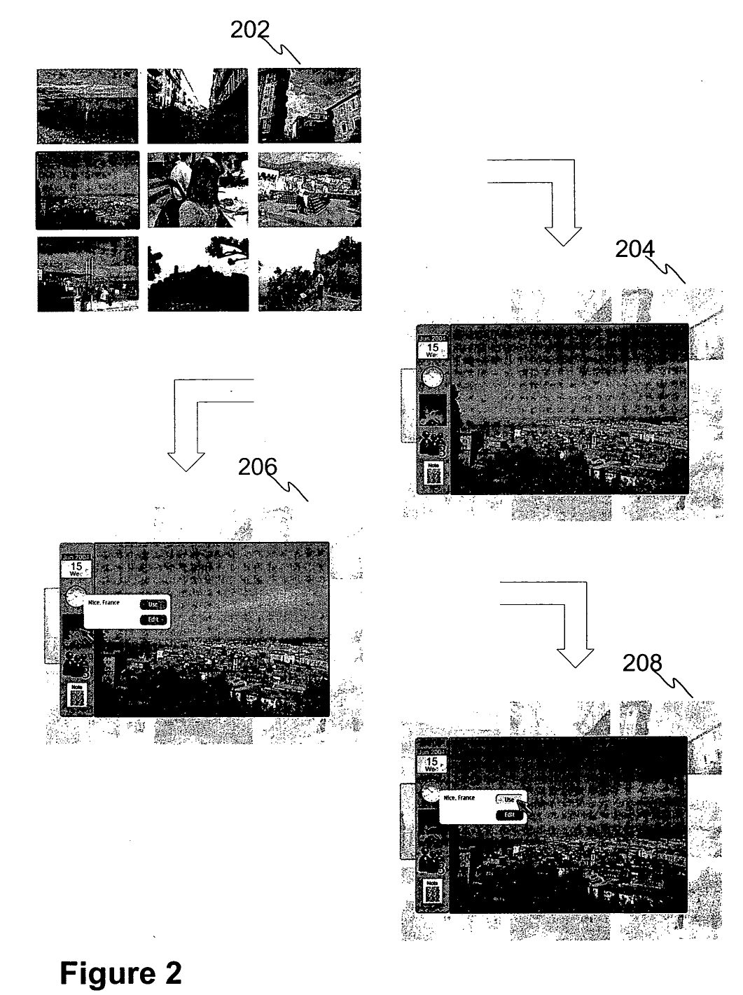

Referring to FIG. 2, the user is browsing his holiday images placed in grid 202 and selects one of them, the leftmost on the centre row being highlighted. The selected image is opened in a bigger scale on the top of grid 204. Metadata attributes associated with the image are displayed as a bar on the left side of the image as icons and/or text. The icons or text labels represent attributes and preferably also their values as exactly as possible (e.g. location can be displayed as a dot on a map, time as an analog clock where a certain “value” is visualized via hands, and date as a calendar sheet); otherwise a more generic icon representing the attribute category can be used. If the user moves a cursor on top of an icon and “hovers” it there, a pop-up note 206 is displayed in the foreground. The note contains an exact value of the attribute as well as controls for using that value or for editing it 208.

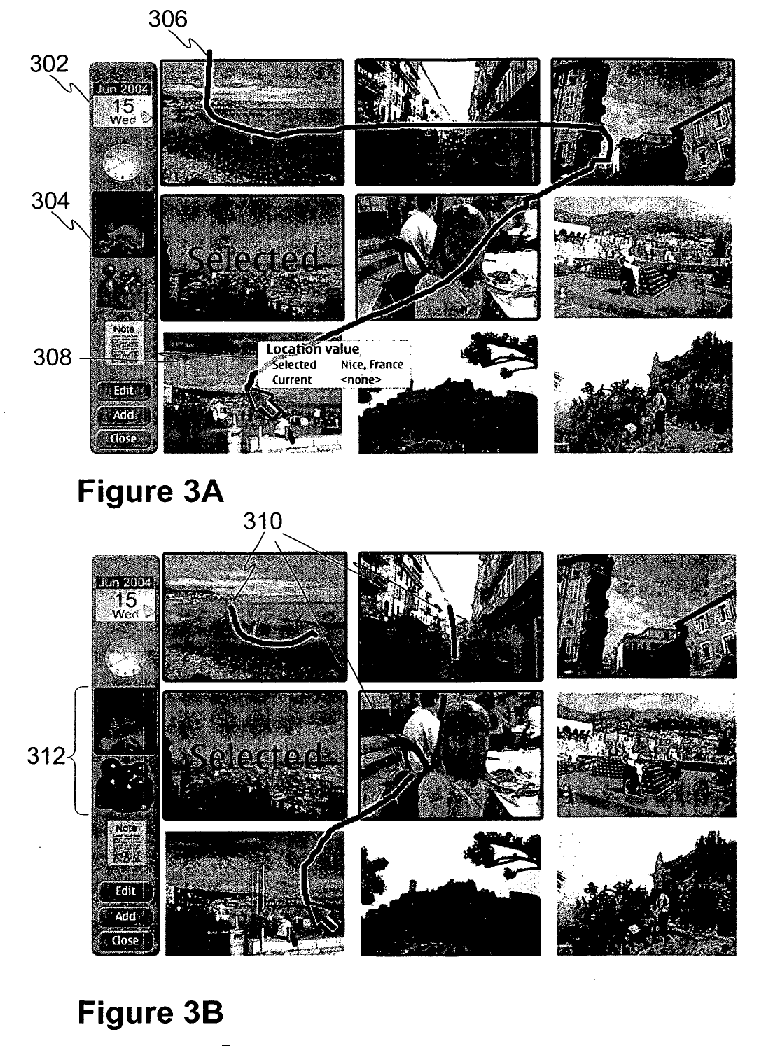

If the user moves the cursor on top of pop-up note and presses “Use” button, the view is changed, please refer to FIG. 3A. Now metadata bar 302 acts as a palette window, where the user can select one or more metadata attributes 304 to be used as colors as in a brush. In this particular example, selected attribute was the location attribute 304 already determined and highlighted in previous stage shown in FIG. 2. The icon of the associated metadata attribute is highlighted and the others are greyed out. The original image containing the selected metadata attributes and values is highlighted. Although not depicted in FIG. 3A or 3B, also other images that may already contain the same selected metadata attributes and values may be marked. This helps the user to see for which images s/he needs to copy the attributes and values. The user can “paint” 306 the selected metadata attributes (and attribute values) on the images as a cursor route, or alternatively without any cursor as becoming evident hereinafter in case of e.g. a touch screen. The system optionally marks the route with e.g. a certain color (per attribute or attribute value, for example) or line type. Also other means such as different border colors for images at least partially covered by the route may be used. If all the attributes do not fit into the palette window the user can advantageously scroll the attributes. Painting (or “drawing”) of the metadata attributes is done by dragging the cursor over those images to which the new metadata attribute(s) is to be applied. The user can end dragging and start it again by e.g. pressing a mouse or other input device button; whichever he chooses. If the cursor is hovered over an image, a tool tip displaying the metadata attribute value is displayed 308. It may also be clever to add easy-to-use controls for editing or adding new metadata (and closing the “paint” mode) as has been done in the case of the figure; see icons on the bottom left corner.

In FIG. 3B multi-selection route feature is explicitly shown; the user may swiftly and easily draw a free-hand route over preferred images and by pressing/releasing control device buttons (e.g. mouse left-side button) suitably, see route portions 310, activate and de-activate the method of the invention. This procedure is obviously more straightforward than exhaustive one-by-one point-and-click type traditional methods. Alternatively, the user could first draw a single route by a single stroke and then separately add additional, independent routes to form the overall, aggregate route by supplementary strokes. Multiple attribute selection 312 is another noticeable issue in FIG. 3B as well. In a case of painting multiple metadata attributes and values, the look of the cursor may be changed in order to highlight the fact that multiple metadata items have been selected. Basically, changing the cursor appearance could also mark moving from the image-browsing mode to the metadata-editing mode.

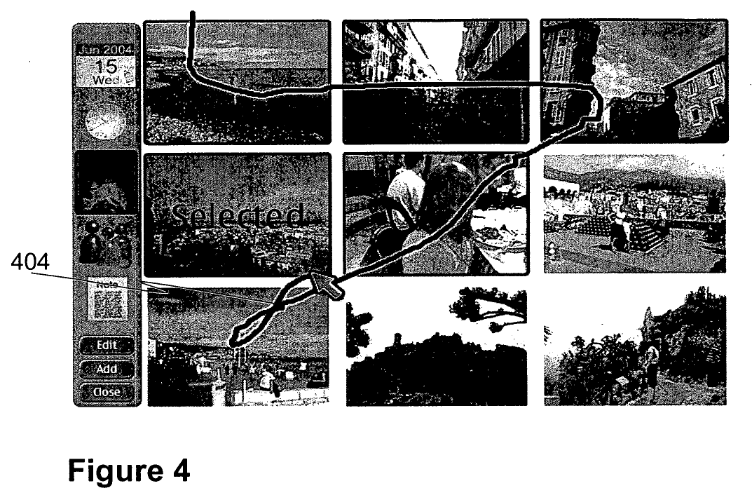

In FIG. 4 it is depicted how undoing a metadata attribute change can also be performed with a paint gesture 404, by selecting and using an unselect tool, or through a context sensitive pop-up menu, for example. Paint gesture 404 may refer, for instance, to a backing up stroke while painting the route.

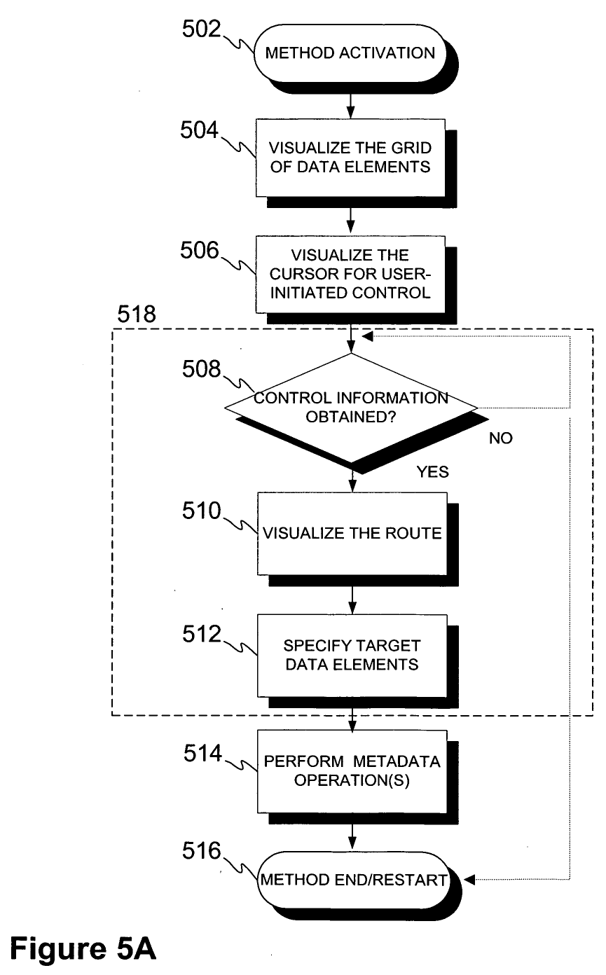

FIG. 5 discloses a first flow diagram disclosing the principles of the invention. It should be noted that the order of phases in the diagram may be varied by any person skilled in the art based on the needs of a particular application. At method start-up or activation 502 the application for data element, e.g. image, management is launched and necessary variables etc are initialized in the executing device. In phase 504 a number of data elements is visualized to the user via a display device. By display device it may be referred to standard internal/external display such as a monitor but also to e.g. different projection means that do not contain the luminous screen themselves. The data elements, or in reality their representations on a display, e.g. shrunk visualized images or icons, shall be arranged in preferred manner, e.g. in a list or a “grid” form thus enabling convenient route selection by a control device.

In phase 506 a cursor is visualized to the user for pointing and thus enabling determination of a preferred route over the visualized data elements. Cursor visualization, functioning and the overall appearance may be (pre-)defined on either an application or a system level, i.e. in modern computer devices the operating system often provides the application with at least basic cursor visualization and input data acquiring algorithms that may be then called by different applications for more specific purposes, e.g. carrying out the invention's cursor/route visualization and input data reception accordingly. Thus, differentiated cursor visualization and user response gathering routines are unnecessary to be implemented for separate applications in a device with pre-programmed basic routines. Anyhow, phase 506 shall be deemed optional in scenarios where e.g. touch screen or some other means not requiring a separate cursor to be first visualized are utilized.

In phase 508 the user determines, with or without the help of the optionally visualized cursor, a route that the executing device receives as control information, e.g. as coordinates, via its data input means such as a peripheral interface to which a mouse has been connected, or via a touch pad/screen. The information received by the device to form the necessary conception of the route as originally intended by the user shall cover a starting point, defined by e.g. mouse/joystick button press or finger/other pointing device press in case of a (pressure sensitive) touch pad/screen, an end point defined by another press or a release accordingly, and a list of route intermediate points, so-called checkpoints, to enable constructing a model with adequate resolution about the building of the desired path between the start and end points. Resolution is adequate when it is not left in uncertainty which of the data elements fell under the route and which not. As one option, touch pads/screens with optical sensors in addition to/instead of pressure sensors may be utilized in which case route definition is at least partly based on changing optical properties of the surface monitored by the sensor due to movement of a pointing device such as a pen or a finger on such surface. The intermediate points of the route are typically defined by the user based on control device, e.g. mouse or a finger in case of a touch screen, movement between said start and end points. The received control information then reflects the movement.

As illustrated in the figure with dotted lines as an exemplary option only, the execution of presented method steps can be either re-started from a desired previous phase or prematurely completely ended. The execution of the method can be continuous or, for example, intermittent and controlled by timed software interrupts etc. Therefore, e.g. phase 508 can be made a decision-making point wherein it is decided whether to continue method execution either from the following phase, to re-execute the current phase in case of no control information obtained, or to end method execution due to the fulfilment of some predetermined criterion, e.g. application shutdown instruction received from the user.

In phase 510 the route defined by the input control information is visualized to the user, via a free-form continuous or dotted line following the cursor movements, or through highlighting the data elements hitting the route, for example. Although the step as such is optional as route visualization is not a necessary task for directing a metadata action in accordance with the invention, it is highly recommended as the user may then quickly realize which data elements were actually addressed as targets for the metadata action compared to the originally intended ones.

Further, route visualization phase 510 can be made dependent on and be performed in connection with or after specification phase 512 where on the basis of the user-defined route the target elements for metadata operation are specified. This may happen by comparing the received route (point) coordinates with the positions of visualized data elements and by analyzing which of the elements fall in the route, for example. It should be evident that if only/also the target elements are to be visualized in contrast to mere route, for determination of which true knowledge about underlying elements is not necessary, specification phase 512 shall be already completed in order to be able to highlight the correct elements in the first place.

In phase 514 the metadata operation and related metadata, which should have been identified by now at the latest as described in the following paragraph, is finally performed and directed to the specified data elements. The operation can, for example, relate to associating a certain metadata attribute with the target data elements, associating a certain metadata attribute value with the target data elements, or even cancelling a recent attribute value change (provided that e.g. metadata attribute selection is not changed but element(s) already fallen in the previous route is now re-painted, or a specific “cancel change” button has been selected prior to determining the route). Phase 516 refers to the end or restart of the method execution.

In FIG. 5B, the phases of metadata attribute determination 520 and attribute value determination 522 are disclosed. Such initial actions are used for defining the metadata operation to be executed in phase 514 and can be accomplished before or after a collective phase 518 shown in both FIG. 5A and FIG. 5B. Determinations may be implemented by gathering relating user input via the UI as explained above in the description of FIGS. 2-4.

In general, one option for carrying out initial actions 520, 522 in the spirit of FIG. 2 includes the steps of visualizing a plurality of data elements such as image files to the user, receiving information about a user selection of one or more data elements belonging to the plurality, resolving (checking on element basis, for example) and visualizing the metadata attributes associated with the selection, optionally receiving information about a sub-selection of the associated metadata attributes or about a number of new user-defined values for the attributes, and finally moving into the primary method of the invention encompassing the route selection and targeting of the metadata operation(s) as disclosed in FIG. 5, whereupon the metadata operation is automatically configured based on the results of initial actions 520, 522. Another option is just to let the user directly determine a number of attributes (from a list etc) and possibly to edit the values thereof via the UI. When constructing the representation for data elements the selected image as well as the images containing the same selected metadata attributes and values may be specifically marked (highlighted).

Although the examples have been put forward with images, the invention may be used with other data and media types.

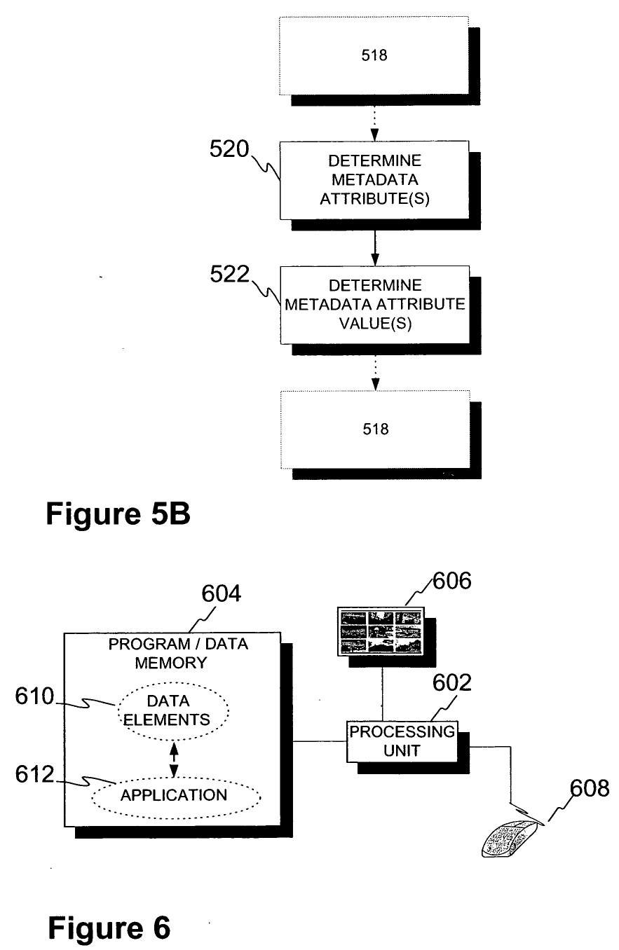

FIG. 6 shows a block diagram of one option of a computer device such as a desktop/laptop computer, a PDA (Personal Digital Assistant), or a (mobile) terminal adapted to execute the inventive method. The device includes processing means 602 in a form of a processor, a programmable logic chip, a DSP, a micro-controller, etc to carry out the method steps as set down by the circuit structure itself or application 612 stored in memory 604. Memory 604, e.g. one or more memory chips, a memory card, or a magnetic disk, further comprises space 610 to accommodate data elements to be cultivated with metadata, space for control information received, etc. It's also possible that memory comprising the data elements is separate (e.g. a memory card inserted in the executing device) from the memory comprising the application 612 logic. Control input means 608, by which it is referred to the actual control means in hands of the user or just appropriate interfacing means, may include a mouse, a keyboard, a keypad, a track ball, a pen, a pressure sensitive touch pad/screen, optical and/or capacitive sensors, etc. Data output means 606 refers to a common computer display (crt, tft, Icd, etc.) or e.g. different projection means like a data projector. Alternatively, data output means 606 may only refer to means for interfacing/controlling the display device that is not included in the device as such.

In addition to data elements also application code 612, generally called a computer program, to carry out the method steps of the invention may be provided to the executing device on a separate carrier medium such as a memory card, a magnetic disk, a cd-rom, etc.

The scope of the invention is found in the following claims. Although a few more or less focused examples were given in the text about the invention's applicability and feasible implementation, purpose thereof was not to restrict the usage area of the actual fulcrum of the invention to any certain occasion, which should be evident to any rational reader. Meanwhile, the invention shall be considered as a novel and practical method for directing metadata operations to a number of data elements through data element visualization and exploitation of related control input.

1. A method for directing a metadata operation at a number of electronically stored data elements in an electronic device having the steps of
visualizing an area with a number of data elements on a display device to a user (504),
obtaining control information about a user-defined route between user-defined start and end points on the visualized area comprising said number of data elements (508),
specifying based on the route such data elements belonging to said number of data elements over which the route passed (512), and
performing the metadata operation on said specified data elements (514).

2. The method of claim 1, further having the step of visualizing a cursor to the user for route definition (506).

3. The method of claim 1, further having the step of visualizing the route (510).

4. The method of claim 3, wherein said route is visualized by a continuous or dotted line between the start and end points.

5. The method of claim 3, wherein said route is visualized by highlighting the specified elements.

6. The method of claim 1, further having the step of determining a certain metadata attribute (520) based on user input.

7. The method of claim 6, further having the step of determining a certain value for the metadata attribute (522).

8. The method of claim 6, wherein the metadata operation incorporates assigning the metadata attribute to the specified data elements.

9. The method of claim 1, wherein the control information is obtained via a keyboard, a mouse, a joystick, a control pen, a track ball, a touch pad, or a touch screen.

10. The method of claim 1, wherein a control device button press or release determines the start or end point of the route.

11. The method of claim 1, wherein the user-defined route comprises a number of start and end point pairs, each having a continuous portion between said start and end points.

12. An electronic device comprising
data output means (606) for visualizing an area with a number of data elements,
data input means (608) for receiving control information from a user, and
processing means (602) configured to determine based on the control information a user-defined route between user-defined start and end points on the visualized area comprising said number of data elements and to specify based on the route such data elements belonging to said number of data elements over which the determined route passed, whereupon said device is further configured to perform a metadata operation on said specified data elements.

13. The device of claim 12, further comprising memory means (604) for storing said data elements (610) or configuration information (612) for the processing means.

14. The device of claim 12, configured to visualize a cursor to the user for route definition.

15. The device of claim 12, configured to visualize the route.

16. The device of claim 15, configured to visualize the route by a continuous or dotted line between the start and end points.

17. The device of claim 15, configured to visualize the route by highlighting the specified elements.

18. The device of claim 12, configured to determine a certain metadata attribute based on user input.

19. The device of claim 18, further configured to determine a certain value for the metadata attribute.

20. The device of claim 18, configured to assign the metadata attribute to the specified data elements in the metadata operation.

21. The device of claim 18, configured to visualize a plurality of data elements to the user, to receive information about a user selection of one or more data elements belonging to the plurality, and to resolve the metadata attributes associated with the selected elements in order to carry out the determination.

22. The device of claim 12, configured to obtain control information inputted via a keyboard, a mouse, a joystick, a control pen, a track ball, a touch pad, or a touch screen.

23. The device of claim 12, wherein said data input means (608) comprises a keyboard, a mouse, a joystick, a control pen, a track ball, a touch pad, or a touch screen.

24. The device of claim 12, configured to determine the start or endpoint of the route based on a press or release of a control device button or a pressure sensitive surface.

25. The device of claim 12, configured to determine intermediate points of the route based on control device movement represented by said control information.

26. The device of claim 12, wherein said data input means (608) comprises an optical or a capacitive sensor.

27. The device of claim 12, configured to determine the route as a number of start and end point pairs, each having a continuous portion between said start and end points.

28. The device of claim 12, wherein said data output means (606) comprises a display or a projector.

29. The device of claim 12 that is a desktop computer, a laptop computer, a PDA (Personal Digital Assistant), or a mobile terminal.

30. A computer program comprising code means (612) for directing a metadata operation at a number of electronically stored data elements, said code means (612) adapted to, when the program is run on a computer device, visualize an area with a number of data elements on a display device to a user, to obtain control information about a user-defined route between user-defined start and end points on the visualized area comprising said number of data elements, to specify on the basis of the route such data elements belonging to said number of data elements over which the route passed, and finally to perform the metadata operation on said specified data elements.

31. A carrier medium having a computer program recorded thereon, the computer program comprising code means adapted to, when the program is run on a computer device, visualize an area with a number of data elements on a display device to a user, to obtain control information about a user-defined route between user-defined start and end points on the visualized area comprising said number of data elements, to specify on the basis of the route such data elements belonging to said number of data elements over which the route passed, and to perform a metadata operation on said specified data elements.

32. The carrier medium of claim 31 that is a memory card, a magnetic disk, or a cd-rom.
